(19) United States
(12) Patent Application Publication
(10) Pub. No.: US 2003/0168284 A1
(43) Pub. Date: Sep. 11, 2003

(54) Power washer attachment device

(76) Inventor: John Martino, Keasbey, NJ (US)

Correspondence Address: Mr. Walter J. Tencza Jr., Suite 3, 10 Station Place, Metuchen, NJ, 08840, US

(21) Appl. No.: 10/095,195

(22) Filed: Mar. 11, 2002

(51) Int. Cl. E06C 5/32

(52) U.S. Cl. 182/129

(57) ABSTRACT

An apparatus comprising an attachment device is disclosed for attaching a portion of a power wash device to an object, such as a ladder. The attachment device allows a user of the power wash device to manipulate the power wash device much more easily due to the reduced length of the hose and total weight the user needs to manage. The attachment device may be comprised of a first clamp and a ring. The ring may be replaced by a second clamp. The ring may be adaptable to be attached to the ladder. The first clamp may be adaptable to be attached to the hose of the power wash device. The first clamp and the ring may be connected together by a chain.

### FIELD OF THE INVENTION

This invention relates to methods and apparatus concerning making tools more easy to control for an individual standing on a ladder.

### BACKGROUND OF THE INVENTION

Tools, such as for example, power wash devices, can be heavy and difficult to control while one is standing on a ladder. For this reason, power washing high exterior areas of a home can be cumbersome and dangerous.

### SUMMARY OF THE INVENTION

The present invention discloses an apparatus comprising an attachment device, wherein the attachment device is adaptable to attach a power wash device to an object, such as a ladder. The attachment device allows a user of the power wash device to manipulate the power wash device much more easily due to the reduced length of the hose and total weight the user needs to manage.

In one embodiment of the present invention the attachment device is comprised of a first clamp and a ring. The ring may be replaced by a second clamp. The ring may be adaptable to be attached to the ladder. The first clamp may be adaptable to be attached to the power wash device. The first clamp and the ring may be connected together. The attachment device may be comprised of a chain. The chain may connect the first clamp to the ring. The first clamp may have a circular cross section. The clamp may be adapted to be connected to the hose of a power wash device.

The present invention also discloses a method comprising the step of attaching a power wash device to a ladder. The power wash device may be attached by a attachment device such as previously described.

### BRIEF DESCRIPTION OF THE DRAWINGS

FIG. 1 shows a perspective view of a ladder, a portion of a power wash device, and a device for attaching the power wash device to the ladder;

FIG. 2A shows a side view of a ring in a closed state for connecting the portion of the power wash device to the ladder;

FIG. 2B shows a side view of a ring in an open state for connecting the portion of the power wash device to the ladder;

FIG. 3 shows a perspective view of a clamp for connecting to the portion of the power wash device; and

FIG. 4 shows a side view of the clamp of FIG. 3.

### DETAILED DESCRIPTION OF THE DRAWINGS

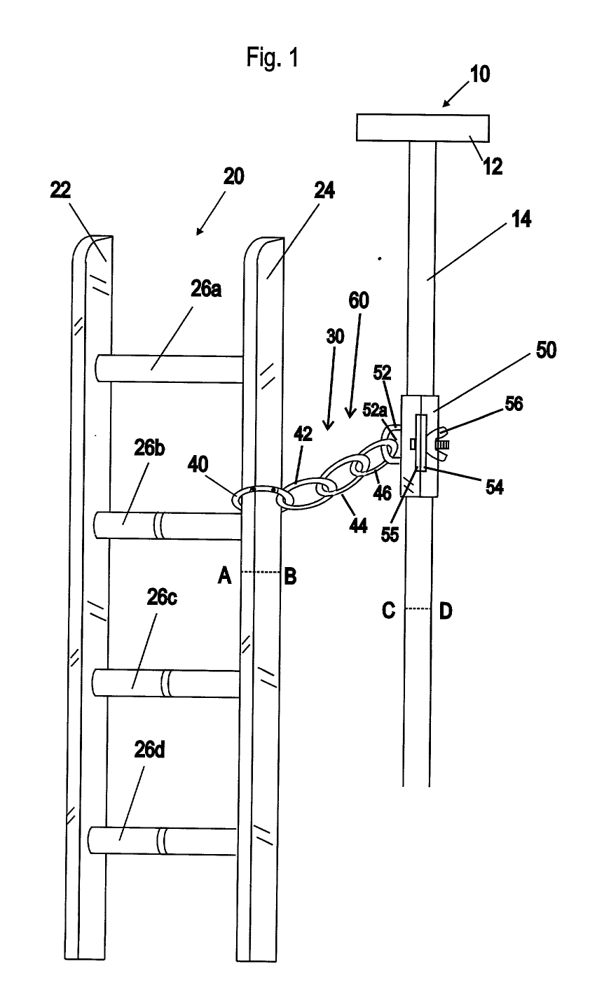

FIG. 1 shows a perspective view of a ladder 20, a portion 10 of a power wash device, and an attachment device 30 for attaching the portion 10 of the power wash device to the ladder 20.

The ladder 20 includes legs 22 and 24. The legs 22 and 24 are connected together by top rung 26a, rungs 26b, 26c, and 26d. The ladder 20 may be replaced by a longer ladder or by an extension ladder. The portion 10 of the power wash device includes a portion 14 of a tube or hose and a nozzle 12.

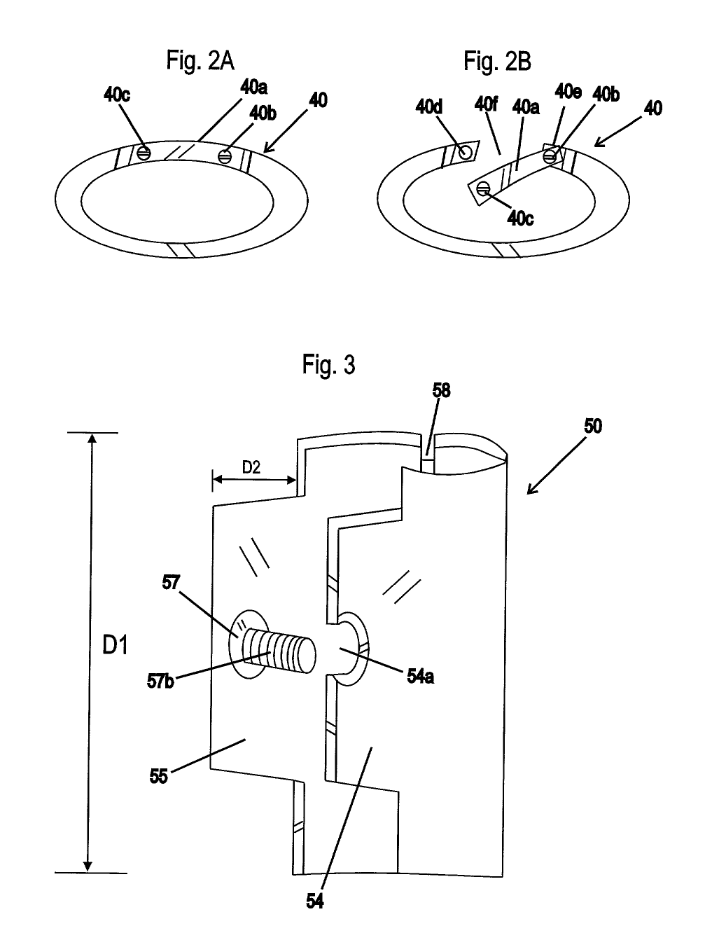

The attachment device 30 includes a rings 40, 42, 44, and 46 and clamp 50. The rings 40, 42, 44, and 46 form a chain 60. The ring 40 is connected to the leg 24 of the ladder 20 between the top rung 26a and the next rung 26b. FIG. 2A shows a side view of the ring 40 in closed state for use on the leg 24 of the ladder 20 in FIG. 1. The ring 40 should be large enough to fit around the leg 24 and to be removed from the leg 24. The ring 40 includes portion 40a which can be placed in a closed state as in FIG. 2A or in an open state as in FIG. 2B. The ring 40 also includes screws or pins 40b and 40c, which fit into holes 40d and 40e respectively. When the ring 40 is placed in the open state of FIG. 2B, the ring 40 can be placed on or removed from the leg 24. The ring 40 can be changed from the closed state of FIG. 2A to the open state of FIG. 2B by removing pin or screw 40c from the hole 40d and rotating the portion 40a from the position in FIG. 2A to the position in FIG. 2B. This opens up a gap 40f through which the ladder leg 24 can fit.

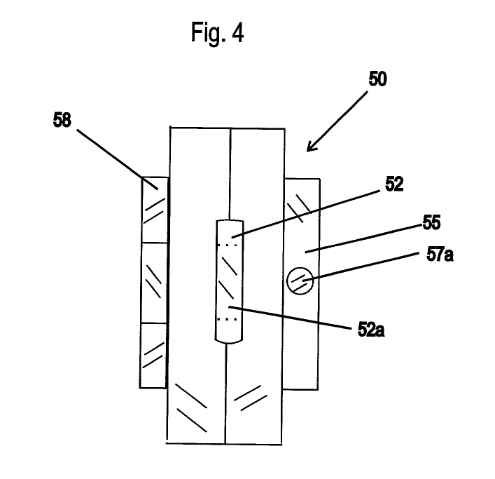

The clamp 50 is clamped to the portion 14 of the hose of the power wash device below the nozzle 12. FIG. 4 shows a perspective view of the clamp 50. The clamp 50 has an extension 52 which has a hole 52a. The clamp 50 when closed may have an interior area 31 which may be circular and may be slightly larger than a circular cross section of the portion 14 of the hose of the power wash device, such as a cross section taken along plane CD, which is perpendicular to portion 14 of the hose.

The clamp 50 also includes extensions 54 and 55. Extension 54 has a curved substantially semicircular indentation 54a, which could alternatively be a hole. Extension 55 has a bolt or screw 57 connected thereto. The clamp 50 also includes a hinge 58 shown in FIGS. 3 and 4. The clamp 50 can be clamped to portion 14 and placed in a closed position as shown in FIG. 1 by rotating the extensions 54 and 55 towards one another about hinge 58, inserting screw 57 into indentation 54a, and threading a wingnut 56 onto a threaded stem 57b of the screw 57. The clamp 50 can be detached from the portion 14 of the power wash device by unscrewing and taking the wingnut 56 off of the stem 57b and rotating the extensions 54 and 55 away from each other. The clamp 50 may have a height of D1 which may be three inches.

In the state of FIG. 1, the ring 40 is to the leg 24 of the ladder 20 and to the ring 42. The ring 42 is attached to the ring 44, the ring 44 is attached to the ring 46, and the ring 46 is attached to the extension 52. The portion 10 of the power wash device is thus attached to the ladder 20.

In operation, an individual attaches the ring 40 to the ladder leg 24 at the location shown in FIG. 1 by opening the ring 40 as in FIG. 2B, placing the ring 40 around the ladder leg 24 and closing the ring 40 as shown by FIGS. 1 and 2A. An individual attaches the clamp 50 to the hose 14 at the location shown in FIG. 1 by opening the clamp as shown in FIG. 3, placing the clamp 50 around the portion 14 of the power wash device, closing the clamp 50, and screwing on the wingnut 56 as shown in FIG. 1. The individual may then lean the ladder 20 against, for example, the exterior of a building, and then may stand on the ladder 20 and use the portion of the power wash device 10 to power wash, for example, an exterior of a building. The portion 14 of the hose may be connected to another hose portion which may be connected to an exterior water faucet or spigot, not shown.

The ring 40 may be replaced by a second clamp which may be similar to the clamp 50. The second clamp may fit around the leg 24 of the ladder 20 at the location of the ring 40 in FIG. 1. In another embodiment of the present invention, the ring 40 may be attached around a railing on a balcony instead of the leg 24 of the ladder 20.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
an attachment device;
wherein the attachment device is adaptable to attach a portion of a power wash device to a ladder.

2. The apparatus of claim 1 wherein
the attachment device is comprised of a first clamp and a ring.

3. The apparatus of claim 1 wherein
the attachment device is comprised of a first clamp and a second clamp;
wherein the first clamp is adaptable to be attached to the ladder;
wherein the second clamp is adaptable to be attached to the portion of the power wash device;
and wherein the first clamp and the second clamp are connected together.

4. The apparatus of claim 3 wherein
the attachment device is comprised of a chain; and
wherein the chain connects the first clamp to the second clamp.

5. The apparatus of claim 1 wherein
the first clamp has a rectangular cross section;
and the second clamp has a circular cross section.

6. The apparatus of claim 1 wherein
the first clamp is adapted to be connected to the leg of a ladder.

7. The apparatus of claim 1 wherein
the second clamp is adapted to be connected to a portion of a hose of a power wash device.

8. The apparatus of claim 4 wherein
the first clamp is comprised of an extension having a hole, the chain connected to the extension of the first clamp through the hole; and
the second clamp is comprised of an extension having a hole, the chain connected to the extension of the second clamp through the hole.

9. A method comprising the step of
attaching a portion of a power wash device to a ladder.

10. The method of claim 9 wherein
the step of attaching includes attaching a ring to a ladder and attaching a clamp to the power wash device.

11. The method of claim 9 wherein
the portion of the power wash device is comprised of a portion of a hose and the step of attaching the portion of the power wash device to the ladder includes attaching the portion of the hose to the ladder.

12. The method of claim 9 wherein
the ladder is comprised of a leg and the step of attaching the portion of the power wash device to the ladder includes attaching the portion of the power wash device to the leg.

13. The method of claim 11 wherein
the ladder is comprised of a leg and the step of attaching the portion of the power wash device to the ladder includes attaching the portion of the power wash device to the leg.

14. The method of claim 9 wherein
the step of attaching the portion of the power wash device to the ladder includes chaining the portion of the power wash device to the ladder.

15. The method of claim 9 wherein
the step of attaching the portion of the power wash device to the ladder includes
attaching a first clamp to the ladder between a top rung of the ladder and a rung below the top rung of the ladder.

16. The method of claim 15 wherein
the step of attaching the portion of the power wash device to the ladder includes
attaching a second clamp to the portion of the power wash device.

17. The method of claim 16 wherein
the step of attaching the portion of the power wash device to the ladder includes
attaching a first end of a chain to the first clamp and the second end of the chain to the second clamp.
